(19) United States
(12) Patent Application Publication
(10) Pub. No.: US 2007/0046634 A1
(43) Pub. Date: Mar. 1, 2007

(54) Wireless method and system for power management of computing devices

(75) Inventor: Dean L. Rice JR., Simi Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Tokyo (JP)

(21) Appl. No.: 11/217,251

(22) Filed: Aug. 31, 2005

(51) Int. Cl. G09G 5/00

(52) U.S. Cl. 345/168

(57) ABSTRACT

A method for operating one or more computing input devices in a power saving mode. The method includes providing a computer input device having a wireless sensing device coupled to a processing unit. The wireless sensing device and the processing unit are provided in a housing of the computing input device. The method includes monitoring for one or more packets using the wireless sensing device from a wireless tag device, which can be portable and capable of being personalized. The method brings the wireless tag device within a selected spatial proximity of the computer input device including the wireless sensing device. The method captures the one or more packets using the wireless sensing device after the wireless tag device is within the selected spatial proximity of the computer input device. The method initiates a wake up process using the processing unit of the computer input device from information derived from the one or more packets from the wireless sensing device.

### BACKGROUND OF THE INVENTION

The present invention is directed to computer hardware and software. In particular, the invention provides a method and system for power management of wireless computing input devices using wireless capabilities. More particularly, the invention provides a method and system for providing security to computing input devices also using wireless capabilities. Merely by way of example, the computing input devices include keyboards and computer mouse, but it would be recognized that the invention has a much broader range of applicability. For example, the invention can be applied to other computing and/or electronic devices.

Computing technologies proliferated over the years. In the early days, large mainframe computers dominated the computing landscape. These large mainframe computers were developed by companies such as IBM Corporation of Armonk, N.Y. Mainframe computers have been replaced, at least in part, by smaller computing devices, commonly known as “PCs.” PCs come in various shapes and sizes. PCs are often run using computer software such as XP™ from Microsoft Corporation from Redmond Wash. Other types of computer software come from Apple Computer of Cupertino, Calif. Smaller PC versions are often called “lap top computers.” Other types of PCs include larger desktop versions. Still other versions of PCs can be found in smaller devices such as personal digital assistants, called PDAs, cellular phones, and a variety of other applications.

All of these computing devices generally require input devices for human users to interact with them. As merely an example, computer keyboards are most commonly used as such input devices for inputting characters, numerals and symbols to electronic devices, particularly to these computing devices such as the PCs. While such keyboards generally connected to the PC main bodies via hardwire cables, various other peripherals including pointing devices such as mice are also connected to the PC main bodies via hard wires.

Unfortunately, certain limitations exist in connecting these peripheral devices and keyboards using hard wires and connectors. That is, cables for connecting peripheral devices can become complicated, causing problems in working on PCs effectively. Accordingly, peripherals connected to the PC main bodies have become wireless (or cable less). Specifically, wireless technologies provide an electrical interface between the PC and peripheral devices. Examples of wireless technologies include radio frequency techniques, commonly called RF. These wireless technologies have been particularly effective for wireless keyboards that interface between the peripherals and PC main bodies.

Although wireless technologies have been successful with certain PC applications, various limitations using wireless technologies still exist. For example, wireless keyboards often include various system elements such as an independent power source, such as direct current power from a conventional chemical battery source such as carbon based batteries. The chemical battery source often has limited life and generally requires replacement after a certain period of operation, which occurs more frequent with more frequent use. Additionally, conventional battery sources are often limited in power and cannot effectively drive certain applications that consume large amounts of power. These and other limitations have been described throughout the present specification and more particularly below.

From the above, it is seen that an improved technique for wireless computing is desired

### BRIEF SUMMARY OF THE INVENTION

According to the present invention, techniques directed to computer hardware and software are provided. In particular, the invention provides a method and system for power management of wireless computing input devices using wireless capabilities. More particularly, the invention provides a method and system for providing security to computing input devices also using wireless capabilities. Merely by way of example, the computing input devices include keyboards, computer mouse, and other devices, but it would be recognized that the invention has a much broader range of applicability. For example, the invention can be applied to other computing devices such as personal computers, personal digital assistants, cell phones, digital cameras, home or office lighting control, door entry control, desktop and notebook computers, computer peripherals, such as keyboard, mice, game controllers, TV/Entertainment systems, any combination of these, and the like. Additionally, the wireless capabilities can include infra-red, radio frequency, commonly called RF, combinations of these technologies, and the like. Depending upon the embodiment, the invention can be applied to access control and/or security for any of the above devices, among others.

In a specific embodiment, the present invention provides a method for operating one or more computing devices in a power saving mode. The method includes providing a computer keyboard having a wireless sensing device (e.g., RF sensor chip), a processing unit (e.g., microprocessor, micro controller), and a housing. The wireless sensing device is coupled to the processing unit. The wireless sensing device and the processing unit are provided in the housing of the computer keyboard. In a preferred embodiment, the keyboard is maintained in a sleep mode to preserve power of the computer keyboard, which has a battery power source. The method includes monitoring a spatial region for one or more packets using the wireless sensing device provided in the computer keyboard from a wireless tag device. The method includes bringing the wireless tag device within a selected spatial proximity to the wireless sensing device provided in the computer keyboard. The method also includes capturing the one or more packets from the wireless tag device using the wireless sensing device. In a preferred embodiment the method includes initiating a wake up process associated with the processing unit of the computer keyboard from information derived from the one or more packets from the wireless sensing device. Depending upon the embodiment, the wake up process can cause for full (and or partial) operation of the MPU (or CPU), wireless device, and/or any of these individually, or together, or with other devices, according to the embodiment.

In an alternative specific embodiment, the present invention provides a method for operating one or more computing input devices in a power saving mode. The method includes providing a computer input device having a wireless sensing device coupled to a processing unit. The wireless sensing device and the processing unit are provided in a housing of the computing input device. The method includes monitoring for one or more packets using the wireless sensing device from a wireless tag device, which can be portable and capable of being personalized. The method brings the wireless tag device within a selected spatial proximity of the computer input device including the wireless sensing device. The method captures the one or more packets using the wireless sensing device after the wireless tag device is within the selected spatial proximity of the computer input device. The method initiates a wake up process using the processing unit of the computer input device from information derived from the one or more packets from the wireless sensing device. Depending upon the embodiment, the wake up process can cause for full (and or partial) operation of the MPU (or CPU), wireless device, and/or any of these individually, or together, or with other devices, according to the embodiment.

In yet an alternative embodiment, the present invention provides a computing device, e.g., mouse, keyboard. The device has a housing. A processing unit is within the housing. The device has a wireless sensing device coupled to the processing unit. The wireless sensing device and the processing unit are provided in the housing of the computing input device. The device has a battery power source coupled to the processing unit and the wireless sensing device. The device has one or more computer memories coupled to the processing unit. Various computer codes are provided within the one or more memories. One or more codes is directed to monitoring for one or more packets using the wireless sensing device from a wireless tag device. One or more codes is directed to capturing the one or more packets using the wireless sensing device after the wireless tag device is within the selected spatial proximity of the computer input device. One or more codes is directed to initiating a wake up process using the processing unit of the computer input device from information derived from the one or more packets from the wireless sensing device. Depending upon the embodiment, the wake up process can cause for full (and or partial) operation of the MPU (or CPU), wireless device, and/or any of these individually, or together, or with other devices, according to the embodiment.

Numerous benefits are achieved using one or more features of the present invention. In a specific embodiment, the present invention can provide a method and system for power consumption that will provide for devices with lifetimes of six months or more using standard power. The present invention also provides a method and system for using conventional computer hardware and software technologies. Additionally, the invention can provide for wireless input devices, which include independent power sources, having larger power consumption features, e.g., light emitting diodes, external cards, smart cards. In a preferred embodiment, the present power consumption techniques can be applied to keyboards, mouse devices, any combination of these, and the like. In other embodiments, the present method and system can be provided for access/control and security for cell phones, digital cameras, home or office lighting control, door entry control, personal digital assistants, desktop and notebook computers, computer peripherals (e.g., keyboard, mice, game controllers), TV/entertainment systems, combinations of these, among others. Depending upon the specific embodiment, the invention also provides a security method using wireless sensing capabilities that are implemented using conventional computer software and hardware. Depending upon the embodiment, one or more of these benefits may be achieved. These and other benefits are described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram of a keyboard device according to an embodiment of the present invention;

FIG. 2 is a simplified side-view diagram of a keyboard device according to an embodiment of the present invention;

FIG. 3 is a simplified back-side diagram of a keyboard device according to an embodiment of the present invention;

FIG. 4 is a simplified block diagram of a keyboard system according to an embodiment of the present invention;

FIG. 5 is a simplified flow diagram of a method for power management according to an embodiment of the present invention;

FIG. 6 is a simplified flow diagram of an alternative method for power management according to an embodiment of the present invention;

FIG. 7 is a simplified flow diagram of a security method for a computer input device according to an embodiment of the present invention; and

FIG. 8 is a simplified flow diagram of “hand shaking” or “binding” process among the various computer elements according to an embodiment of the present invention.

### DETAILED DESCRIPTION OF THE INVENTION

According to the present invention, techniques directed to computer hardware and software are provided. In particular, the invention provides a method and system for power management of wireless computing input devices using wireless capabilities. More particularly, the invention provides a method and system for providing security to computing input devices also using wireless capabilities. Merely by way of example, the computing input devices include keyboards, computer mouse, and other devices, but it would be recognized that the invention has a much broader range of applicability. For example, the invention can be applied to other computing devices such as personal computers, personal digital assistants, cell phones, digital cameras, home or office lighting control, door entry control, desktop and notebook computers, computer peripherals, such as keyboard, mice, game controllers, TV/Entertainment systems (e.g., set top box), any combination of these, and the like. Additionally, the wireless capabilities can include infra-red, radio frequency, commonly called RF, combinations of these technologies, and the like. Depending upon the embodiment, the invention can be applied to access control and/or security for any of the above devices, among others.

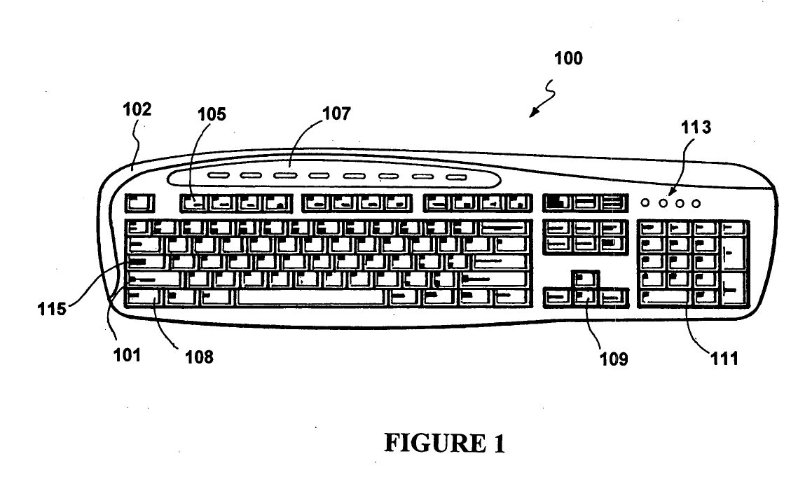

FIG. 1 is a simplified diagram of a keyboard device 100 according to an embodiment of the present invention. This diagram is merely an example, which should not unduly limit the scope of the claims herein. One of ordinary skill in the art would recognize other variations, modifications, and alternatives. As shown, the keyboard device 100 includes housing member 102. In specific embodiment, the housing member is often made of a suitable plastic material and/or metal that has support and can protect the internal devices in the keyboard. The housing includes a plurality of conventional keys 101. The conventional keys include alphanumeric keys, e.g., letters and numbers. The keyboard also has punctuation keys, e.g., comma, period, semicolon, question mark.

As also shown, the keyboard has special keys 105, 109, 111. As shown, the special function keys include function keys 107, control keys 108, arrow keys 109, Caps Lock key 115, and a numerical pad 111, among others. In a specific embodiment, the standard layout is commonly known as a “QWERTY” keyboard because the first six keys on the top row of letters spell QWERTY. Other types of keyboard designs include the Dvorak keyboard. Other types of keys can be Page Up, Page Down, Home, End, Insert, Pause, Num Lock, Scroll Lock, Break, Caps Lock, Print Screen as featured in an IBM style keyboard design.

In a preferred embodiment, the keyboard also has certain power consuming elements and/or devices 113. These power consuming elements include light emitting diodes, commonly termed LEDs. The elements also include specialized input devices such as those for Smart Cards, PCMCIA type, one or more liquid crystal displays, back lighting for display devices, backlight (e.g., LEDs (e.g., blue, red, white, green, amber))coupled to each key) of key caps, any combination of these, and the like. Of course, there can be other variations, modifications, and alternatives.

In a specific embodiment, the keyboard has wireless devices. These wireless devices allow the keyboard and its functionality interface with personal computers, laptop computers, television sets, and other computing based units. To provide power for these wireless devices, the keyboard has an independent battery power source. In a specific embodiment, the power source can be two or more AA batteries and/or other like type of power sources. In a preferred embodiment, the keyboard also has a wireless power savings process. Of course, there can be other variations, modifications, and alternatives. Further details of the keyboard can be found throughout the present specification and more particularly below.

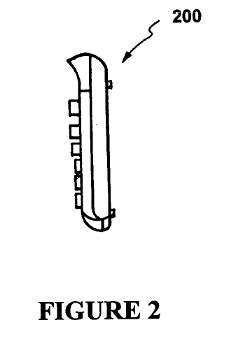

FIG. 2 is a simplified side-view diagram 200 of a keyboard device according to an embodiment of the present invention. This diagram is merely an example, which should not unduly limit the scope of the claims herein. One of ordinary skill in the art would recognize other variations, modifications, and alternatives.

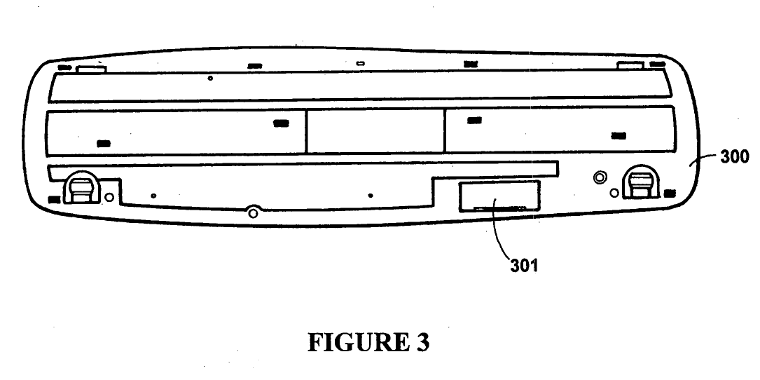

FIG. 3 is a simplified back-side diagram 300 of a keyboard device according to an embodiment of the present invention. This diagram is merely an example, which should not unduly limit the scope of the claims herein. One of ordinary skill in the art would recognize other variations, modifications, and alternatives. As shown, the backside includes an area for inserting a battery 301, which may be a single and/or multiple power sources according to a specific embodiment. Details of specific functional elements within the keyboard are provided throughout the present specification and more particularly below.

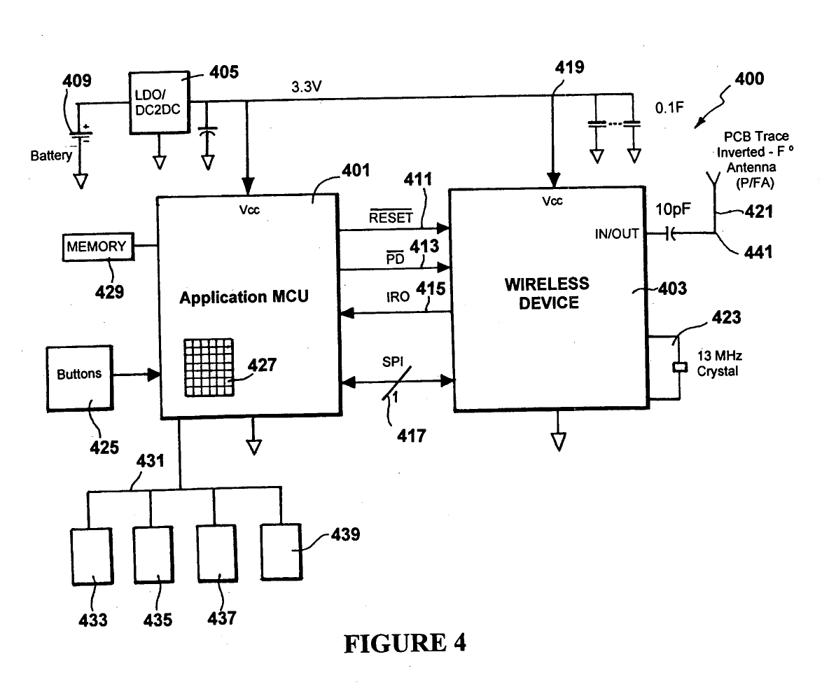

FIG. 4 is a simplified block diagram of a keyboard system 400 according to an embodiment of the present invention. This diagram is merely an example, which should not unduly limit the scope of the claims herein. One of ordinary skill in the art would recognize other variations, modifications, and alternatives. As shown, the system 400 includes various elements. These elements include a micro controller unit, commonly termed MCU, coupled to a wireless unit 403. The MCU is general purpose and suitable for use in the keyboard. The MCU often has a clock speed of 1 Mega Hertz and greater and also has memory 427, which may be embedded and/or external 429 memory, to the MCU according to a specific embodiment. As merely an example, the MCU can be an Encore Series from Cypress Semiconductor Corporation of California, but can be others. Other types of MCU can be from Zilog Corporation, Intel Corporation, and other companies. Of course, there can be other variations, modifications, and alternatives.

In a specific embodiment, the memory can be any suitable memory for holding various computer codes for operating at least the present methods. These memories can be volatile, such as dynamic random access memory, static random access memory, and/or Flash memory, e.g., NAND Flash. Preferably, the memory does not require a high amount of power consumption. Of course, there can be various alternatives, modifications, and variations.

As shown, the MCU couples to each of the keyboard buttons 425. The MCU often generates one or more keyboard output signals corresponding to respective one or more depression (or movements) from each key on the keyboard. The MCU transmits via SPI interface 417 the output signals to the wireless device, which outputs corresponding wireless telecommunication signals via antenna 421. Other interfaces between the wireless device and MCU include a RESET 411, IPD (Power Down) 413, IRQ (Interrupt) 415, and there also may be other elements, depending upon the specific embodiment.

In a specific embodiment, the wireless unit 403 transmits/receives wireless signals. As noted keyboard signals converted by the MCU are transmitted via the wireless device and antenna to the computing device, such as PCs, laptop computers, work stations, and other applications. The wireless unit also includes power Vcc 419 from a power source 409. The wireless unit is also coupled to an oscillator and/or crystal 423, which provides a 13 Mega Hertz signal in a specific embodiment.

In a preferred embodiment, the wireless unit also includes a receive antenna 441, which may be the same as the transmit antenna. In a preferred embodiment, the receive antenna “sniffs” the spatial region for one or more packets from a tag device. Depending upon the embodiment, the wireless unit can use one or more wireless formats such as Blue Tooth format, IEEE 802.11 Series, and others. Depending upon the specific embodiment, the wireless unit can also be characterized by a carrier frequency of 2.4 GHz and greater, 13.0 Mega Hertz and greater, and others. The wireless unit can use various technologies such as RF sensing, infra-red sensing, and others. Of course, one of ordinary skill in the art would recognize various alternatives, modifications, and variations.

As also noted, the system has power source 409, which supplies power to the MCU, wireless unit, and other elements. That is, the power source is for supplying a direct current to the MCU and the wireless unit. The power source is generally formed at a suitable position in a bottom portion of the housing of the keyboard housing in such a way that it can be removed from the back of the bottom housing. As merely an example, the power source can be a carbon based battery or lithium based batteries, depending upon the embodiment. In a specific embodiment using the power source, the computer keyboard is stand alone and is free of an AC adapter. The power source is coupled to a voltage regulator 415, which couples to ground and has a capacitor coupled between the voltage regulator output and MCU and wireless unit according to a specific embodiment. Of course, there can be other variations, modifications, and alternatives.

In a preferred embodiment, the system also includes various power consuming devices 433, 435, 437, 439, among others. These elements receive signals from the MCU and are powered by the power source 409. The elements include a display (e.g., LCD, CMOS) 433, smart card reader 435, light emitting diodes 437, and others 439. In a specific embodiment, one or more power consuming elements uses about 50 milli-Amps having a voltage at about 3.3 volts and less. In an alternative specific embodiment, one or more power consuming elements uses about 50 milli-Amps at a voltage of about 3.3 volts and less. In a preferred embodiment, the keyboard including the one or more power consuming devices is operable at normal consumption for six months or more with a conventional power source, e.g., two AA batteries.

To turn on and turn off the MCU and related circuitry and elements using the present method and system, a wireless tag device is brought within a certain vicinity of the keyboard. Depending upon the specific embodiment, the wireless tag device can be almost any type of device capable of sending out one or more packets and/or other signals to turn on and/or turn off the MCU and related circuitry and elements. As merely an example, the wireless tag can be a personal digital assistant (PDA), cellular phone, gaming device, machine console, printer, card, automobile key, pen, any combination of these, and others. In a preferred embodiment, the wireless tag device is provided by a human user of the wireless tag device. Of course, there can be other variations, modifications, and alternatives.

A method for power management of a keyboard according to an embodiment of the present invention can be briefly outlined below.

1. Provide a wireless keyboard in sleep mode;

2. Periodically wake the wireless keyboard in sleep mode to sniff using a wireless sensing device in the wireless keyboard for one or more packets in a selected spatial region from an RF tag device;

3. Move the RF tag device within the selected spatial region;

4. Wake up the keyboard and associated system based upon information derived from sniffing of the one or more packets form the RF tag device;

5. Scan for movement of one or more keys from the keyboard;

6. Provide an interrupt process upon a detection of movement from one or more keys from the keyboard;

7. Re-scan keyboard movement to determine which one or more keys have been pressed;

8. Repeat at least process steps 5, 6, and 7;

9. Remove the RF tag device from the selected spatial region associated with the keyboard;

10. Sense using the sensing device of the removed RF tag device by a lack of packets, which are now out of range of the sensing device;

11. Initiate sleep mode of the wireless keyboard; and

12. Perform other steps, as desired.

The above sequence of steps provides a power saving method for a computer keyboard according to an embodiment of the present invention. As shown, the method uses a combination of steps including a way of detecting for the RF tag device to initiate operation from a power saving sleep mode and place the keyboard back into a sleep mode. Other alternatives can also be provided where steps are added, one or more steps are removed, or one or more steps are provided in a different sequence without departing from the scope of the claims herein. Further details of the present method can be found throughout the present specification and more particularly below.

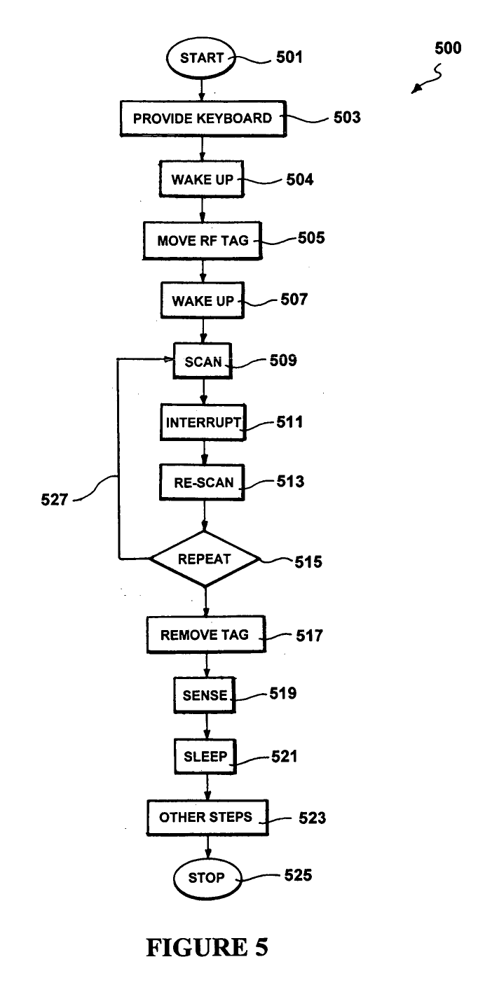

FIG. 5 is a simplified flow diagram 500 of a method for power management according to an embodiment of the present invention. This diagram is merely an example, which should not unduly limit the scope of the claims herein. One of ordinary skill in the art would recognize other variations, modifications, and alternatives. As shown, the method is for power management of a keyboard, which begins at start, step 501. The method includes providing a wireless keyboard (step 503) in sleep mode. In a preferred embodiment, the sleep mode corresponds to low activity of an MPU and wireless device to preserve power. As an example, the MPU and wireless device consumes power of about a fraction of a percent or percentages and less according to a specific embodiment.

In a specific embodiment, the method periodically wakes (step 504) the wireless keyboard in sleep mode to sniff using a wireless sensing device in the wireless keyboard for one or more packets in a selected spatial region from an RF tag device. Depending upon the specific embodiment, the wireless tag device can be almost any type of device capable of sending out one or more packets and/or other signals to turn on and/or turn off the MCU and related circuitry and elements. As merely an example, the wireless tag can be a personal digital assistant (PDA), cellular phone, gaming device, machine console, printer, card, automobile key, pen, any combination of these, and others. In a preferred embodiment, the wireless tag device is provided by a human user of the wireless tag device. Of course, there can be other variations, modifications, and alternatives.

As shown, the method moves the RF tag device within the selected spatial region. That is, the wireless tag device is often held by a human user, which accesses and/or approaches the keyboard. As the human user becomes spatially closer to the keyboard, the tag device's signals falls within the selected spatial region of the wireless device's sensing capabilities according to a specific embodiment. Of course, there can be other variations, modifications, and alternatives.

In a specific embodiment, the method wakes up (step 507) the keyboard and associated system based upon information derived from sniffing of the one or more packets form the RF tag device. The keyboard is now operational and can communicate with a computing system, such as a personal computer, and or other associated system. That is, the keyboard is now at full power and operational according to a specific embodiment. In a specific embodiment, the one or more packets include information that the wireless device senses to initiate the wake up process to power on the keyboard and associated system. Of course, there can be other variations, modifications, and alternatives.

Once the keyboard is operational, the method scans (step 509) for movement of one or more keys from the keyboard. The method provides an interrupt process (step 511) upon a detection of movement from one or more keys from the keyboard. In a specific embodiment, the method re-scans (step 513) the keyboard movement to determine which one or more keys have been pressed. Depending upon the embodiment, method can repeat (step 515) at least the scanning, interrupt, and rescanning process via branch 527. Of course, there can be other variations, modifications, and alternatives.

In a specific embodiment, the method removes (step 517) the RF tag device from the selected spatial region associated with the keyboard. That is, the user moves the RF tag device away from the selected spatial region for receiving wireless signals from the RF tag device. In a specific embodiment, the method senses (step 519) using the sensing device of the removed RF tag device by a lack of packets, which are now out of range of the sensing device, as noted. Once the one or more packets are not sensed, the method initiates a sleep mode (step 521) for the keyboard. Depending upon the embodiment, the method can perform other steps, step 523. The method stops, step 525. Of course, there can be other variations, modifications, and alternatives.

The above sequence of steps provides a power saving method for a computer keyboard according to an embodiment of the present invention. As shown, the method uses a combination of steps including a way of detecting for the RF tag device to initiate operation from a power saving sleep mode and place the keyboard back into a sleep mode. Other alternatives can also be provided where steps are added, one or more steps are removed, or one or more steps are provided in a different sequence without departing from the scope of the claims herein. Additionally, although the above has been described in terms of a keyboard device, other devices can also be used. Further details of these other devices using the present method can be found throughout the present specification and more particularly below.

A method for performing power management of a computer mouse according to an embodiment of the present invention is briefly outlined below;

1. Provide mouse device including MCU and wireless device in sleep mode;

2. Periodically wake mouse device including MCU and wireless device to sniff for one or more packets from an RF tag device;

3. Move RF tag device within a spatial region of the mouse device;

4. Receive one or more packets from the mouse device;

5. Wake up mouse device and system (and Agilent chip) based upon information from the one or more packets from the RF tag device;

6. Scan movement of the mouse device;

7. Provide interrupt upon movement from the mouse device;

8. Re-scan to determine which one or more features of the mouse device have been moved;

9. Repeat steps 6, 7, and 8;

10. Remove physical presence of the RF tag device from the spatial region of the mouse device;

11. Sense removal of RF tag by lack of packets (since the signal from the RF tag is out of range);

12. Initiate sleep mode; and

13. Perform other steps, as desired.

The above sequence of steps provides a power saving method for a computer mouse according to an embodiment of the present invention. As shown, the method uses a combination of steps including a way of detecting for the RF tag device to initiate operation from a power saving sleep mode and place the mouse back into a sleep mode. Other alternatives can also be provided where steps are added, one or more steps are removed, or one or more steps are provided in a different sequence without departing from the scope of the claims herein. Further details of the present method can be found throughout the present specification and more particularly below.

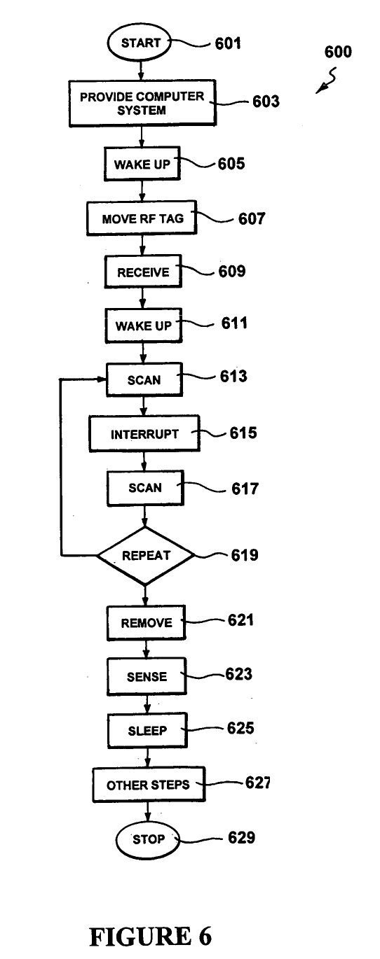

FIG. 6 is a simplified flow diagram 600 of an alternative method for power management according to an embodiment of the present invention. This diagram is merely an example, which should not unduly limit the scope of the claims herein. One of ordinary skill in the art would recognize other variations, modifications, and alternatives. As shown, the method is for power management of a mouse device, which begins at start, step 601. The method includes providing a wireless mouse device (step 603) in sleep mode. In a preferred embodiment, the sleep mode corresponds to low activity of an MPU and wireless device to preserve power. As an example, the MPU and wireless device consumes power of about a determined percent and less according to a specific embodiment.

In a specific embodiment, the method periodically wakes (step 605) the wireless mouse device in sleep mode to sniff using a wireless sensing device in the wireless mouse device for one or more packets in a selected spatial region from an RF tag device. Depending upon the specific embodiment, the wireless tag device can be almost any type of device capable of sending out one or more packets and/or other signals to turn on and/or turn off the MCU and related circuitry and elements. As merely an example, the wireless tag can be a personal digital assistant (PDA), cellular phone, gaming device, machine console, printer, card, automobile key, pen, any combination of these, and others. In a preferred embodiment, the wireless tag device is provided by a human user of the wireless tag device. Of course, there can be other variations, modifications, and alternatives.

As shown, the method moves (step 607) the RF tag device within the selected spatial region. That is, the wireless tag device is often held by a human user, which accesses and/or approaches the mouse device. As the human user becomes spatially closer to the mouse device, the tag device's signals falls within the selected spatial region of the wireless device's sensing capabilities according to a specific embodiment. Of course, there can be other variations, modifications, and alternatives.

In a specific embodiment, the method includes receiving (step 609) one or more packets from the RF tag device. In a specific embodiment, the method wakes up (step 611) the mouse device and associated system based upon information derived from sniffing of the one or more packets from the RF tag device. The mouse device is now operational and can communicate with a computing system, such as a personal computer, and or other associated system. That is, the mouse device is now at full power and operational according to a specific embodiment. In a specific embodiment, the one or more packets include information that the wireless device senses to initiate the wake up process to power on the mouse device and associated system. Of course, there can be other variations, modifications, and alternatives.

Once the mouse device is operational, the method scans (step 613) for movement of one or more keys and/or movement of the mouse device itself. The method provides an interrupt process (step 615) upon a detection of movement from one or more keys from the mouse device and/or the mouse device itself. In a specific embodiment, the method re-scans (step 617) the mouse device for movement to determine which one or more keys have been pressed and/or the movement of the mouse device itself. In a specific embodiment, the mouse device can use a sensing unit such as those Agilent HDNS-2000 Series Products manufactured by Agilent Technologies, Inc. of Palo Alto Calif., but can be others. Depending upon the embodiment, method can repeat (step 619) at least the scanning, interrupt, and rescanning process via branch 618. Of course, there can be other variations, modifications, and alternatives.

In a specific embodiment, the method removes (step 621) the RF tag device from the selected spatial region associated with the mouse device. That is, the human user moves the RF tag device away from the selected spatial region for receiving wireless signals from the RF tag device. In a specific embodiment, the method senses (step 623) using the sensing device of the removed RF tag device by a lack of packets, which are now out of range of the sensing device, as noted. Once the one or more packets are not sensed, the method initiates a sleep mode (step 625) for the keyboard. Depending upon the embodiment, the method can perform other steps, step 627. The method stops, step 629. Of course, there can be other variations, modifications, and alternatives.

The above sequence of steps provides a power saving method for a computer keyboard according to an embodiment of the present invention. As shown, the method uses a combination of steps including a way of detecting for the RF tag device to initiate operation from a power saving sleep mode and place the keyboard back into a sleep mode. Other alternatives can also be provided where steps are added, one or more steps are removed, or one or more steps are provided in a different sequence without departing from the scope of the claims herein. Additionally, although the above has been described in terms of a keyboard device, other devices can also be used. Further details of these other devices using the present method can be found throughout the present specification and more particularly below.

A method for providing security using a tag device is briefly outlined below:

1. Provide computer system (including a CPU and wireless device) in a sleep mode (All files on computer system are encrypted and not viewable by any attacker; if the computer system is lost or stolen, any unauthorized user cannot use any of the files, and the computer system will not function, which serves as a deterrent for a thief.);

2. Periodically wake system with wireless device to sniff for one or more packets from the RF tag device;

3. Move RF tag device with a spatial region of the system;

4. Receives by the system one or more packets from the RF tag device via a secure channel (which includes strong encryption, secure key generation and passing, digital signing, authentication, and mode of transfer of information between devices—the secure channel makes the device “attack proof”);

5. Wake up system based on information from the one or more packets from the RF tag device;

6. Invoke user to type a password to access the operating system (optional step for greater security);

7. Turn on operating system, if the password is correct;

8. Use computer system (All files are now viewable and system will now function);

9. Move tag device away from system;

10. Sense lack of one or more packets from the RF tag device;

11. Turn off system and place in sleep mode (again all files are immediately encrypted and not viewable and not usable); and

12. Perform other steps, as desired.

The above sequence of steps provides a security method for a computer system according to an embodiment of the present invention. As shown, the method uses a combination of steps including a way of using the RF tag device to initiate operation from a security process. Other alternatives can also be provided where steps are added, one or more steps are removed, or one or more steps are provided in a different sequence without departing from the scope of the claims herein. Further details of the present method can be found throughout the present specification and more particularly below.

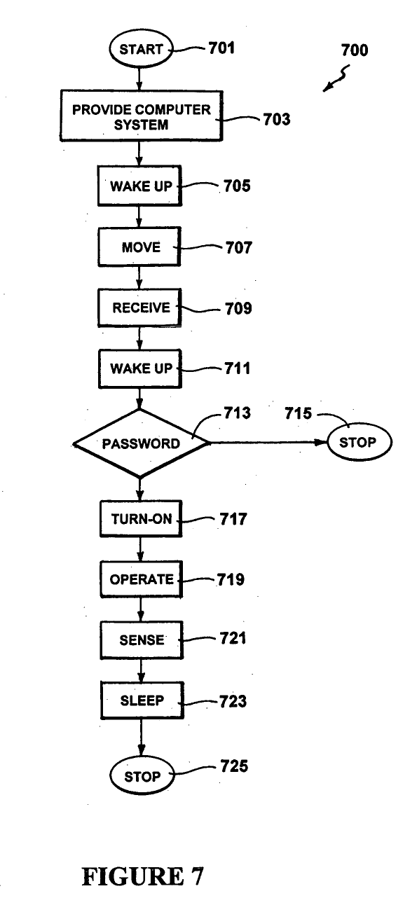

FIG. 7 is a simplified flow diagram 700 of a security method for a computer input device according to an embodiment of the present invention. This diagram is merely an example, which should not unduly limit the scope of the claims herein. One of ordinary skill in the art would recognize other variations, modifications, and alternatives. As shown, the method begins with start, step 701, which provides one or more security techniques using RF tags or other wireless transmission devices.

In a specific embodiment, the present method provides a computer system, step 703. The computer system includes a CPU and wireless device in a sleep mode according to a preferred embodiment. The computer system may also include an MPU and a wireless device according to an alternative embodiment. Depending upon the embodiment, one or more or all files on computer system have been encrypted and are not viewable by any attacker. If the computer system is lost or stolen, any unauthorized user cannot use any of the files, and the computer system will not function, which serves as a deterrent for a thief and/or any unauthorized user according to a specific embodiment.

In a specific embodiment, the method includes a step of periodically waking (step 705) the system with the wireless device to sniff for one or more packets from the RF tag device. Depending upon the specific embodiment, the wireless tag device can be almost any type of device capable of sending out one or more packets and/or other signals to turn on and/or turn off the MCU and related circuitry and elements. As merely an example, the wireless tag can be a personal digital assistant (PDA), cellular phone, gaming device, machine console, printer, card, automobile key, pen, any combination of these, and others. In a preferred embodiment, the wireless tag device is provided by a human user of the wireless tag device. Of course, there can be other variations, modifications, and alternatives.

In a specific embodiment, the RF tag device includes a biological sensing device provided within and/or on the RF tag device. The biological sensing device can include a finger print sensing device, a eye scan device, a chemical sensor device, among others. In a specific embodiment, using the RF tag with the finger print sensing device, the computer system does not require any finger print sensing device. Of course, there can be other variations, modifications, and alternatives.

The method includes moving the RF tag device with a spatial region of the system according to a specific embodiment. That is, the wireless tag device is often held by a human user, which accesses and/or approaches the mouse device. As the human user becomes spatially closer to the mouse device, the tag device's signals falls within the selected spatial region of the wireless device's sensing capabilities according to a specific embodiment. Of course, there can be other variations, modifications, and alternatives.

In a specific embodiment, the method includes receiving (step 709) by the system one or more packets from the RF tag device via a secure channel. In a preferred embodiment, the secured channel is characterized by encryption, a secure key generation, and passing, digital signing, authentication, and mode of transfer of information between RF tag and computer system. In a preferred embodiment, the secure channel makes the communication between the RF tag device and the system substantially “attack proof.” Of course, there can be other variations, modifications, and alternatives.

The method includes waking up (step 711) the system based on information from the one or more packets from the RF tag device according to a specific embodiment. In a preferred embodiment, the method can invoke the human user to type a password (step 713) to access the operating system (optional step for greater security). If the password is accepted, the method continues to the next step. Alternatively, the method goes to stop, step 715, according to a specific embodiment.

In a specific embodiment, the method turns on (step 717) the operating system, if the password is correct. The method allows for operation and/or use (step 721) of the computer system according to a preferred embodiment. Once the security process has been completed, all files provided on one or more memories of the computer system are now viewable and system will now function in a conventional manner. To deactivate the computer, the method continues to the next series of steps using the RF tag device.

In a specific embodiment, the method removes the RF tag device from the selected spatial region associated with the mouse device. That is, the human user moves the RF tag device away from the selected spatial region for receiving wireless signals from the RF tag device. In a specific embodiment, the method senses (step 721) using the sensing device of the removed RF tag device by a lack of packets, which are now out of range of the sensing device, as noted. Once the one or more packets are not sensed, the method initiates a sleep mode (step 723) for the computer system. Depending upon the embodiment, the method can perform other steps. The method stops, step 725. Of course, there can be other variations, modifications, and alternatives. In a preferred embodiment, once the computer system is in sleep mode all files provided on the one or more memories of the computer system are immediately encrypted and not viewable and not usable by any unauthorized user. Of course, there can be other modifications, variations, and alternatives.

The above sequence of steps provides a security method for a computer system according to an embodiment of the present invention. As shown, the method uses a combination of steps including a way of using the RF tag device to initiate operation from a security process. Other alternatives can also be provided where steps are added, one or more steps are removed, or one or more steps are provided in a different sequence without departing from the scope of the claims herein.

Although the above has been described in terms of a computer system, there can be various modifications, alternatives, and variations. Additionally, using the RF tag device for initiating use of the computer system, a screen saver could pop up as soon as the user walks toward the computer system and/or the screen saver could pop down as soon as the user walks away from the computer system. Also the screen saver would not pop up when the user is sitting next to the computer system, thus saving the annoyance to having to type in the password each time. Additionally, any of the methods can be used for any other electronic and/or computer devices such as cellular phones, digital cameras, among others. A single RF tag device can enable many target devices according to a specific embodiment. That is, there may be no need to have multiple RF tag device for user to carry—only one that can serve many functions according to a specific embodiment. Additionally, the RF tag device and RF sensing device, can be replaced by any suitable wireless device using infra-red technologies, and the like. Of course, there can be other variations, modifications, and alternatives.

### EXAMPLES

1. Keyboard Configuration in Connection with the RF Sensor/Tag

In a specific embodiment, the keyboard is normally in the sleep mode (e.g., very low power consumption). The keyboard wakes up every few seconds (e.g., 3 seconds for convenience). When it wakes up, it turns on the RF radio section and puts it into the receive mode, which is now ready to receive packets. The RF radio section “sniffs” for a certain amount of time—enough time (e.g., 100 milliseconds) to sense if the RF tag is transmitting anything. In a specific embodiment, the one or more packets associated with a message from the RF tag takes 5 milliseconds to send and receive. The RF tag transmitter must turn on at least every 95 milliseconds and send the 5 millisecond message to the RF radio section of the keyboard (otherwise the keyboard may miss the message altogether). Once the RF section receives the message, it wakes up from the sleep mode according to a specific embodiment.

In a preferred embodiment, the method and system saves power and/or consumes less battery power for a certain time for the keyboard. That is, the keyboard is wireless and has power consumption devices such as LEDs on it. By using the method and system, the LEDs could be turned off until the user is within close proximity of the keyboard, then the LEDs turn on according to a specific embodiment. Accordingly, about 20 mA for driving the LEDs is saved during the power off period. In a specific embodiment, the method uses power to turn on every 3 seconds to sniff the spatial region for the user. As merely an example if the average current while receiving is 8 mA (typical for Wireless USB), then the keyboard would consume 8 mA for this 100 ms, or 0.8 mA during the 3.1 second interval. The consumption is 0.8 mA/3.1 s=0.26 mA average current. So the power savings is basically 20 mA/0.26 mA=77 times less power for the keyboard according to a specific embodiment. Of course, there can be other variations, modifications, and alternatives.

Of course if any key is hit on the keyboard, then it would wake up, turn on the RF radio, send a message, then turn off the RF radio. If any key is hit, the MCU gets an interrupt, and the keyboard starts scanning the keyboard. Only after all keys are up for a certain amount of time, then the RF tag protocol would need to begin to check if the user is still present according to a specific embodiment. In an alternative embodiment, the RF tag is initially a receiver, and the keyboard system is the transmitter. When the RF tag gets close to the system, the RF tag receives the message, then sends a “system wake-up” message back to the system, which now acts as the receiver. The message from the system can wake up the system and the keyboard (and mouse or anything else). Of course, there can be other variations, modifications, and alternatives.

2. Memory Configuration for Two or More Electronic Devices/Computer Devices:

In a specific embodiment, the system and keyboard and all peripheral devices are electronically linked to each other. In a specific embodiment, each of the peripheral devices is configured so that cross-connection problems do not occur. To do this, only a few bytes of identification information are stored on each peripheral device that would link them to a specific system. In addition to the memory, the embodiment also includes a method for providing a linking procedure to prevent the cross connection problems and/or other issues according to a specific embodiment. Of course, there are other variations, modifications, and alternatives. Further details of the present method can be found throughout the present specification and more particularly below.

A method for electronic binding two or more electronic and/or computer devices together can be briefly outlined as follows:

1. User pushes button on dongle, or clicks on “bind” icon if receiver is embedded within a personal computer.

2. Dongle goes into receive mode, looking for specific codes from peripheral device.

3. User pushers “bind” button on peripheral device. Peripheral device sends unique binding codes over to receiver dongle. The peripheral device also stores this unique binding code in non-volatile memory.

4. Receiver dongle stores this binding code in non-volatile memory on the dongle.

5. Each time a packet is sent by the peripheral device, it contains this binding code somewhere in the packet. This way it can differentiate its packets from all other packets not meant for it.

6. In this way, the peripheral device and receiver dongle are bound “one-to-one”.

7. This method can be done automatically, without any buttons, by using RF proximity sensing techniques (where the initiation of the dongle process occurs using RF proximity).

8. Perform other steps, as desired.

The above sequence of steps provides an electronic binding or handshaking process for two or more computer and/or electronic elements according to an embodiment of the present invention. As shown, the method uses a combination of steps including a way of electronically binding two or more computer and/or electronic elements together to prevent any security and/or operation problems according to an embodiment of the present invention. Other alternatives can also be provided where steps are added, one or more steps are removed, or one or more steps are provided in a different sequence without departing from the scope of the claims herein.

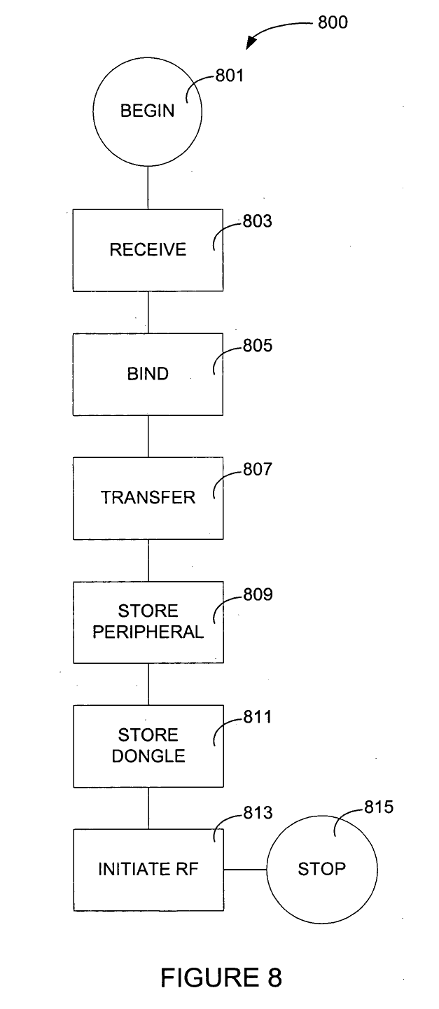

FIG. 8 is a simplified flow diagram 800 of “hand shaking” or “binding” process among the various computer elements according to an embodiment of the present invention. This diagram is merely an example, which should not unduly limit the scope of the claims herein. One of ordinary skill in the art would recognize other variations, modifications, and alternatives. As shown, the method includes providing (step 801) an indication from a computing device to begin a binding process according to a specific embodiment. In a specific embodiment, the method includes a process where a user of the computing device pushes button on a dongle, and/or clicks on “bind” icon on a display of a computer if receiver is embedded within a personal computer. In a preferred embodiment, the user brings an RF tag device with certain binding code within a spatial region of one or more computing devices to initiate the dongle process.

In a specific, embodiment, the term “dongle” is generally a type of a mechanism for allowing only authorized users to use and/or copy specific application software and/or access certain hardware. As merely examples, which should not unduly limit the scope of the claims herein, dongle mechanisms can include a key (e.g., hardware) that may plug into a port, such as parallel and/or serial of a computer and/or computing device and/or other electronic device according to a specific embodiment. One or more software and/or firmware applications accesses the dongle mechanism for verification before continuing to run; special key diskettes accessed in a similar manner; and registration numbers that are loaded into some form of memory at a factory and/or during system setup. In a preferred embodiment, the present method and system uses an RF tag to initiate the dongle process to verify the identity of the user of the one or more computing and/or electronic devices. Of course, there can be other variations, modifications, and alternatives.

In a specific embodiment, the method includes putting the dongle into a receive mode (step 803). The dongle looks for specific codes from a peripheral device according to a specific embodiment. Next, the method includes a step where the user initiates (e.g., pushes) a “bind” button (step 805) on the peripheral device according to a specific embodiment. In a preferred embodiment, the method includes a step of bringing an RF tag device to initiate a dongle process on the peripheral device. Peripheral device sends (step 807) unique binding codes over to receiver dongle. The peripheral device also stores (step 809) the unique binding code in non-volatile memory according to a specific embodiment.

The method includes storing (step 811) the binding code in the receiver dongle using non-volatile memory or other like memory according to a specific embodiment. Each time a packet (or packets) is sent by the peripheral device, it contains the binding code somewhere in the packet. This way it can differentiate its packets from all other packets not meant for it to maintain the “handshaking” process between the dongle and peripheral device according to a specific embodiment. That is, the peripheral device and receiver dongle are bound “one-to-one” according to a preferred embodiment.

In a preferred embodiment as noted above, the method occurs automatically, without any buttons, using RF proximity sensing techniques. That is, the method begins by bringing an RF tag within a spatial region of the peripheral device and/or dongle and/or other like device according to a specific embodiment. In a preferred embodiment, the RF tag initiates the process by transferring one or more packets with the binding code, which was stored in the RF tag, among the receiver dongle and/or peripheral device, and/or other like devices. Depending upon the embodiment, the RF proximity techniques can replace a portion or each of the mechanical sensing techniques to initiate the dongle process. Of course, there can be other variations, modifications, and alternatives.

The above sequence of steps provides an electronic binding or handshaking process for two or more computer and/or electronic elements according to an embodiment of the present invention. As shown, the method uses a combination of steps including a way of electronically binding two or more computer and/or electronic elements together to prevent any security and/or operation problems according to an embodiment of the present invention. Other alternatives can also be provided where steps are added, one or more steps are removed, or one or more steps are provided in a different sequence without departing from the scope of the claims herein. That is, the present method can be combined with any of the methods and/or systems described herein as well as outside of the present specification.

3. Security:

In a specific embodiment, the RF tag can be used to provide security to the computing system. That is, the RF tag can replace the user having to type in a password each time the system asks for it. Of course the level of security can be adjusted by the user, so that the user must both have the RF tag and type in the password if he so wishes. Or the user can just use the RF tag to replace all passwords. Of course all messages sent from the RF tag would be encrypted, perhaps using AES with a 256-bit key. Also a secure message handling protocol would be employed.

While the above is a full description of the specific embodiments, various modifications, alternative constructions and equivalents may be used. As part of the security process and system, the “physical security” part, all the above can be enabled/disabled by the RF tag according to a specific embodiment. Additionally, the RF tag would be linked to the device “one-to-one”, so that only that particular RF tag can enable the target device. The one to one way, if any of the above devices are stolen from the user, they will be useless to the thief or unauthorized user, since he/she will not have the RF tag to enable them. This is a great deterrent to stealing this type of product. Therefore, the above description and illustrations should not be taken as limiting the scope of the present invention which is defined by the appended claims.

What is claimed is:

1. A method for operating one or more computing devices in a power saving mode, the method comprising:
providing a computer keyboard having an wireless sensing device, a processing unit, and a housing, the wireless sensing device being coupled to the processing unit, the wireless sensing device and the processing unit being provided in the housing of the computer keyboard;
monitoring a spatial region for one or more packets using the wireless sensing device provided in the computer keyboard from an wireless tag device;
bringing the wireless tag device within a selected spatial proximity to the wireless sensing device provided in the computer keyboard;
capturing the one or more packets from the wireless tag device using the wireless sensing device; and
initiating a wake up process associated with the processing unit of the computer keyboard from information derived from the one or more packets from the wireless sensing device.

2. The method of claim 1 wherein the wireless sensing device uses a Blue Tooth format.

3. The method of claim 1 wherein the wireless sensing device is characterized by a carrier frequency of 2.4 GHz and greater.

4. The method of claim 1 wherein the wireless sensing device is characterized by a carrier frequency of 13.0 MegaHz and greater.

5. The method of claim 1 wherein the wireless sensing device comprises an RF sensing device.

6. The method of claim 1 wherein the wireless sensing device comprises an infra-red sensing device.

7. The method of claim 1 wherein the wireless tag device is provided from one or more devices selected from a personal digital assistant (PDA), cellular phone, gaming device, machine console, printer, card, automobile key, and pen.

8. The method of claim 1 wherein the bringing the wireless tag device is provided by a human user of the wireless tag device.

9. The method of claim 1 wherein the processing unit is characterized by a clock speed of 1 Megahertz and greater.

10. The method of claim 1 wherein the computer keyboard is stand alone having an independent power source, the independent power source comprises a battery, the computer keyboard is free of an AC adapter.

11. The method of claim 1 wherein the computer keyboard is stand alone having an independent power source, the independent power source comprises at least one AA-type battery.

12. The method of claim 1 wherein the keyboard comprises one or more light emitting diode devices.

13. The method of claim 1 wherein the keyboard comprises a display device coupled to the keyboard.

14. The method of claim 1 wherein the keyboard comprises a smart card reader.

15. The method of claim 1 wherein the keyboard comprises one or more power consuming elements, one or more power consuming elements using about 1 milli-Amps and a voltage greater at about 3.3 volts and less.

16. The method of claim 1 wherein the keyboard comprises one or more power consuming elements, one or more power consuming elements using about 50 milli-Amps and greater at about 3.3 volts and less; and wherein the operating is provided for six months or more for an independent power source.

17. A method for operating one or more computing input devices in a power saving mode, the method comprising:
providing a computer input device having a wireless sensing device coupled to a processing unit, the wireless sensing device and the processing unit being provided in a housing of the computing input device;
monitoring for one or more packets using the wireless sensing device from a wireless tag device, the wireless tag device being portable and capable of being personalized;
bringing the wireless tag device within a selected spatial proximity of the computer input device including the wireless sensing device;
capturing the one or more packets using the wireless sensing device after the wireless tag device is within the selected spatial proximity of the computer input device; and
initiating a wake up process using the processing unit of the computer input device from information derived from the one or more packets from the wireless sensing device.

18. The method of claim 17 wherein the wireless sensing device uses a Blue Tooth format.

19. The method of claim 17 wherein the wireless sensing device is characterized by a carrier frequency of 2.4 GHz and greater.

20. The method of claim 17 wherein the wireless sensing device is characterized by a carrier frequency of 13.0 MegaHz and greater.

21. The method of claim 17 wherein the wireless sensing device comprises an RF sensing device.

22. The method of claim 17 wherein the wireless sensing device comprises an infra-red sensing device.

23. The method of claim 17 wherein the wireless tag device is selected form a PDA, cellular phone, gaming device, machine console, printer, card, automobile key, and pen.

24. The method of claim 17 wherein the bringing the wireless tag device is provided by a human user of the wireless tag device.

25. The method of claim 17 wherein the processing unit is characterized by a clock speed of 1 Megahertz and greater.

26. The method of claim 17 wherein the computer input device is stand alone having an independent power source, the independent power source comprises a battery, the computer input device is free of an AC adapter.

27. The method of claim 17 wherein the computer input device is stand alone having an independent power source, the independent power source comprises at least two AA batteries.

28. The method of claim 17 wherein the computer input device comprises one or more light emitting diode devices.

29. The method of claim 17 wherein the computer input device comprises a display device coupled to the computer input device.

30. The method of claim 17 wherein the computer input device comprises a smart card reader.

31. The method of claim 17 wherein the computer input device comprises one or more power consuming elements, one or more power consuming elements using about 50 milli-Amps and greater at about 3.3 volts.

32. The method of claim 17 wherein the computer input device comprises one or more power consuming elements, one or more power consuming elements using about 50 milli-Amps and greater at about 3.3 volts and wherein the operating is provided for six months or more for an independent power source.

33. The method of claim 17 wherein the personalized information is associated with a security process.

34. A computing device, the computing device comprising:
a housing:
a processing unit within the housing;
a wireless sensing device coupled to the processing unit, the wireless sensing device and the processing unit being provided in the housing of the computing input device;
a battery power source coupled to the processing unit and the wireless sensing device;
one or more computer memories coupled to the processing unit, the one or more computer memories including:
one or more codes directed to monitoring for one or more packets using the wireless sensing device from a wireless tag device, the wireless tag device being portable and capable of being personalized;
one or more codes directed to capturing the one or more packets using the wireless sensing device after the wireless tag device is within the selected spatial proximity of the computer input device; and
one or more codes directed to initiating a wake up process using the processing unit of the computer input device from information derived from the one or more packets from the wireless sensing device.

35. The system of claim 34 wherein the wireless sensing device uses a Blue Tooth format.

36. The system of claim 34 wherein the wireless sensing device is characterized by a carrier frequency of 2.4 GHz and greater.

37. The system of claim 34 wherein the wireless sensing device is characterized by a carrier frequency of 13.0 Mega Hz and greater.

38. The system of claim 34 wherein the wireless sensing device comprises an RF sensing device.

39. The system of claim 34 wherein the wireless sensing device comprises an infra-red sensing device.

40. The system of claim 34 wherein the wireless tag device is selected form a PDA, cellular phone, gaming device, machine console, printer, card, automobile key, and pen.

41. The system of claim 34 wherein the processing unit is characterized by a clock speed of 1 Megahertz and greater.

42. The system of claim 34 wherein the power supply is a battery.

43. The system of claim 34 wherein the computer input device is stand alone having an independent power source, the independent power source comprises a battery, the computer input device is free of an AC adapter.

44. The system of claim 34 wherein the computer input device is stand alone having an independent power source, the independent power source comprises at least two AA batteries.

45. The system of claim 34 wherein the computer input device comprises one or more light emitting diode devices.

46. The system of claim 34 wherein the computer input device comprises a display device coupled to the computer input device.

47. The system of claim 34 wherein the computer input device comprises a smart card reader.

48. The system of claim 34 wherein the computer input device comprises one or more power consuming elements, one or more power consuming elements using about 50 milli-Amps and greater at about 3.3 volts.

49. The system of claim 34 wherein the computer input device comprises one or more power consuming elements, one or more power consuming elements using about 50 milli-Amps and greater at about 3.3 volts and wherein the operating is provided for six months or more for an independent power source.

50. The system of claim 34 wherein the personalized information is associated with a security process.
